(19) United States
(12) Patent Application Publication
(10) Pub. No.: US 2020/0380257 A1
(43) Pub. Date: Dec. 3, 2020

(54) AUTONOMOUS VEHICLE OBJECT CONTENT PRESENTATION SYSTEMS AND METHODS

(71) Applicant: Pony.ai, Inc, Fremont, CA (US)

(72) Inventors: Xing He, Beijing (CN); Xiang Yu, Santa Clara, CA (US); Tiancheng Lou, Milpitas, CA (US); Jun Peng, Fremont, CA (US)

(21) Appl. No.: 16/425,675

(22) Filed: May 29, 2019

(51) Int. Cl. G06K 9/00; G05D 1/02; G05D 1/00; G06K 9/32; B60W 50/14

(52) U.S. Cl. CPC G06K 9/00664; G06K 9/00201; G05D 1/0212; G05D 2201/0213; G05D 1/0088; G06K 9/325; B60W 50/14; G05D 1/0238

(57) ABSTRACT

Systems and methods directed to recognizing, displaying, identifying, and labeling of an object along a direction of motion of the autonomous along a road is disclosed. In some embodiments, an autonomous vehicle with a light projector is disclosed, where the light projector is on a top surface of an autonomous vehicle. Additionally, in some embodiments, the autonomous vehicle may include an electronic control unit for controlling an operation of the light projector, where the electronic control unit detects whether the autonomous vehicle is turned on. In further embodiments, the electronic control unit receives data of an environmental condition surrounding the autonomous vehicle and receives an upcoming trajectory path of the autonomous vehicle. The electronic control unit may also project a light from the light projector onto a surface of a road indicating an adjusted direction of motion of the autonomous vehicle based on confirmation by the occupant of the identifying and the labeling of the object utilizing one or more autonomous vehicle actions.

### TECHNICAL FIELD

The present disclosure relates generally to autonomous vehicles. In particular, some embodiments relate to object content presentation and to adjust a direction of motion of the autonomous vehicle on a surface of a road.

### BACKGROUND

Autonomous vehicles are self-driving vehicles that are capable of sensing the environment and navigating the road without continuous human input. As a result, autonomous vehicles may detect its immediate surroundings using radar, lidar, cameras, GPS, Odometry, computer vision, and the like.

Autonomous vehicles provide the potential advantages of decreasing traffic collision caused by human errors, such as those caused by delayed reaction time, tailgating, drinking and driving, speeding, distractions, and aggressive driving. While autonomous vehicles continue to advance its technology with enhanced driving control systems and safety mechanisms to ensure the reliability and safety of autonomous vehicles, people have yet to fully trust autonomous technology. Accordingly, communications between autonomous vehicle and occupant make augment autonomous vehicle functionality.

### SUMMARY

Various embodiments of the present disclosure include systems, methods, and non-transitory computer readable media configured to obtain autonomous vehicle sensor data, the autonomous vehicle sensor data being used to recognize an object in the direction of motion of the autonomous vehicle. A layout of the object is displayed as a heads up display along an outline of the object. The object is identified and labeled on the layout of the object based on a live search of an on-line database. Other sensor data is obtained from one or more other sensors disposed within the autonomous vehicle. The layout of the object and labeling of the object data and the other sensor data are integrated. An adjusted direction of motion is presented to an occupant of the autonomous vehicle. The occupant can be a driver or a passenger. The adjusted direction of motion of the autonomous vehicle is based on confirmation by an occupant of the identifying and the labeling of the object utilizing one or more autonomous vehicle actions. The direction of motion of the autonomous vehicle is estimated based on the integrated data, and the autonomous vehicle direction of motion is controlled based on inputs from the occupant.

In some embodiments, the one or more autonomous vehicle actions include any of steering, accelerating, and braking.

In some embodiments, the presenting the adjusted direction of motion includes the presenting of the direction of motion within the autonomous vehicle.

In some embodiments, the presenting of the adjusted direction of motion includes the projecting of a light arrow in-front of the direction of motion of the autonomous vehicle to indicate the adjusted direction of motion of the autonomous vehicle.

In some embodiments, the presenting the direction of motion includes instructing the occupant who is a driver that a dangerous or difficult condition has occurred and to take manual control of the autonomous vehicle.

In some embodiments, the object is identified and labeled on the layout of the object based on a live search of an on-line database includes the occupant checks the accuracy of the identifying and labeling of the object, and confirms or changes by the occupant the labeling of the layout of the object. In related embodiments, the object identified and labeled on the layout of the object is based on a live search of an on-line database includes the occupant confirms agreement of the identifying and labeling of the object as an interest to the occupant. In related embodiments, any contact information of the interest is communicated electronically to the occupant.

In some embodiments, the autonomous vehicle direction of motion is adjusted based on confirmation by an occupant of the identifying and the labeling of the object utilizing one or more autonomous vehicle actions includes the direction of motion of the autonomous vehicle direction of motion is adjusted based on a recognition of a characteristic. For example, the recognition of the characteristic can be when the object is a vehicle having a license plate that is confirmed by the occupant as being a suspect vehicle identified from the on-line data base as being stolen, in a recent crime, or has been published on the on-line database as being in an active car chase. Continuing with this example, after confirmation by the occupant, the suspect vehicle whereabouts is reported via a telephone communication to a police agency as a possible crime suspect.

In some embodiments, the object is identified and labeled on the layout of the object based on a live search of an on-line database includes an augmented image displayed either inside or outside the autonomous vehicle. In a related embodiment, an augmented image displayed either inside or outside the autonomous vehicle includes identity labeling on the object so that the occupant can visualize the object and confirm or deny its identity.

In some embodiments, the controlling the autonomous vehicle includes any of allowing the autonomous vehicle to perform one or more autonomous vehicle actions, and preventing the autonomous vehicle from performing one or more autonomous vehicle actions. In related embodiments, the one or more autonomous vehicle actions include any of accelerating, braking, turning an engine of the autonomous vehicle off, and turning the engine of the autonomous vehicle on.

Various embodiments of the present disclosure include systems, methods, and non-transitory computer readable media configured to obtain autonomous vehicle sensor data of an autonomous vehicle. One or more autonomous vehicle actions of the autonomous vehicle are predicted based on the autonomous vehicle sensor data. Interactive content is identified from an on-line database. The interactive content is adjusted based on the predicted one or more autonomous vehicle actions, and the adjusted interactive content is presented within the autonomous vehicle.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A is an image illustrating an example of a heads up display labeling an object that is a vehicle for sale by vehicle owner and/or a vehicle owner looking for friends in accordance with various embodiments of the disclosure.

FIG. 1B is an image illustrating an example of a heads up display labeling an object that is a pedestrian/suspect in a crime in accordance with various embodiments of the disclosure.

FIG. 1C is an image illustrating an example of a heads up display mistakenly labeled as a vehicle but is an object that is a couch/sofa in accordance with various embodiments of the disclosure.

FIG. 1D is a schematic representation of an object content presentation system of an autonomous vehicle in accordance with various embodiments of the disclosure.

FIG. 2 is schematic representation of a vehicle communication system in accordance with various embodiments of the disclosure.

FIG. 3A is an illustration of an autonomous vehicle recognizing an object in a direction of motion along a road in accordance with various embodiments.

FIG. 3B is an illustration of an autonomous vehicle displaying a layout of the object on a heads up display along an outline of the object in a direction of motion along a road in accordance with various embodiments.

FIG. 3C is an illustration of an autonomous vehicle identifying and labeling the layout of the object based on a live search of an on-line database in a direction of motion along a road in accordance with various embodiments.

FIG. 3D is an illustration of an autonomous vehicle presenting an adjusted direction of motion along a road and/or on a screen to an occupant in accordance with various embodiments by projecting an upcoming stopping point or change of direction on a surface of a road in accordance with various embodiments.

FIG. 4 is an illustration of an autonomous vehicle adjusting the direction of motion along a road and/or on a screen based on confirmation by the occupant of the identifying and the labeling of the object in accordance with various embodiments.

FIG. 5 is an exemplary process for an object content presentation system of an autonomous vehicle in accordance with various embodiments.

FIG. 6 is an example computing component that may be used to implement various features of embodiments described in the present disclosure.

The figures are not exhaustive and do not limit the present disclosure to the precise form disclosed.

### DETAILED DESCRIPTION

Autonomous vehicles may include one or more sensors and equipment to recognize one or more objects around them. After recognizing the objects, the vehicle may create an augmented display on the windshield and other windows of the vehicle to create outlines and labels. For example, for individuals in front of the car such as a pedestrian, the display augmented display on the actual person, if the label around the person is a light post, then an occupant in the vehicle knows the car has made a mistake and may need input from the occupants to correct the mistake.

In other embodiments, the autonomous vehicle may recognize a license plate or other characteristics of the objects using a live search of online database and provides labels such as but not limited to, “owner is interested in making new friends,” or the individual may be a “crime suspect”, “Toyota is on sale now in San Francisco”, “driver looks drunk, stay away”. For example, if the driver/passenger agrees with the label “crime suspect” recognition, the occupants are offered a choice to report the sighting to the police. If the occupant of the vehicle is interested in buying the vehicle, then the vehicle may offer a phone number to call or the like.

In various embodiments, the vehicle may suggest a next move in response to the sensed objects, such as but not limited to, slow down, make a right turn, will yield to a pedestrian. The showing of the next move can be a visual projection of a virtual arrow on the road or showing the next move on the augmented display. After suggesting the next move, the vehicle may give the occupants an option to provide feedback regarding whether the suggested next move is approved and/or the label of the object is correct. Upon receiving the instruction from the driver/passenger regarding the difficult conditions the autonomous vehicle may take over control/avoid the crowd/reduce the speed of the vehicle by applying the brake.

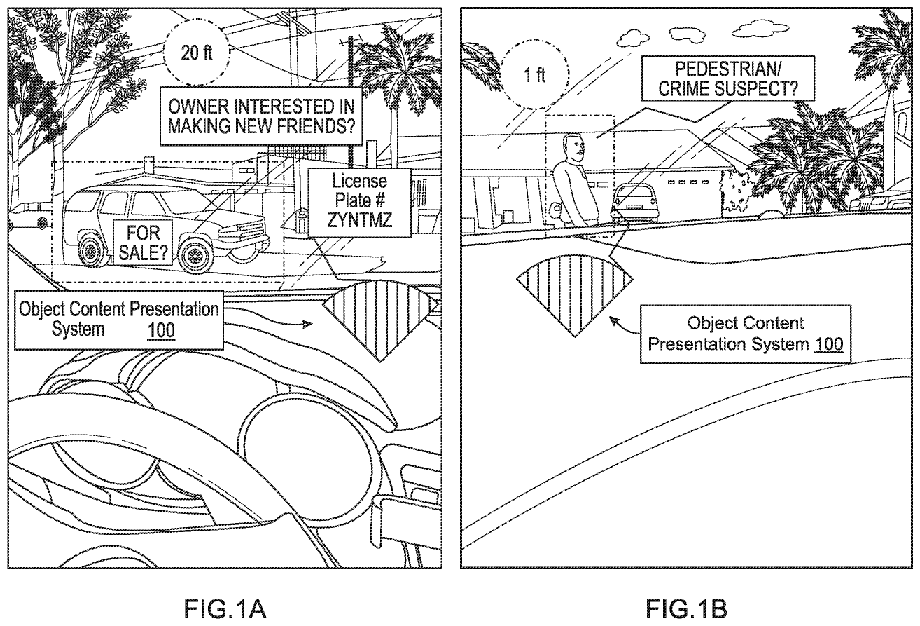

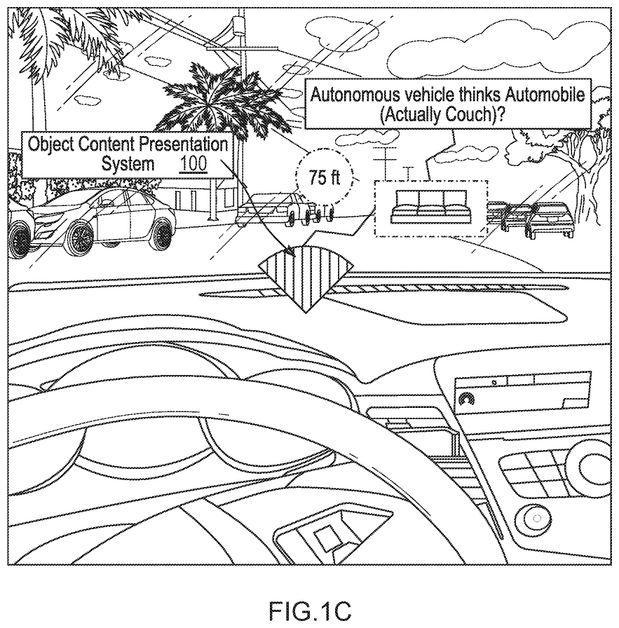

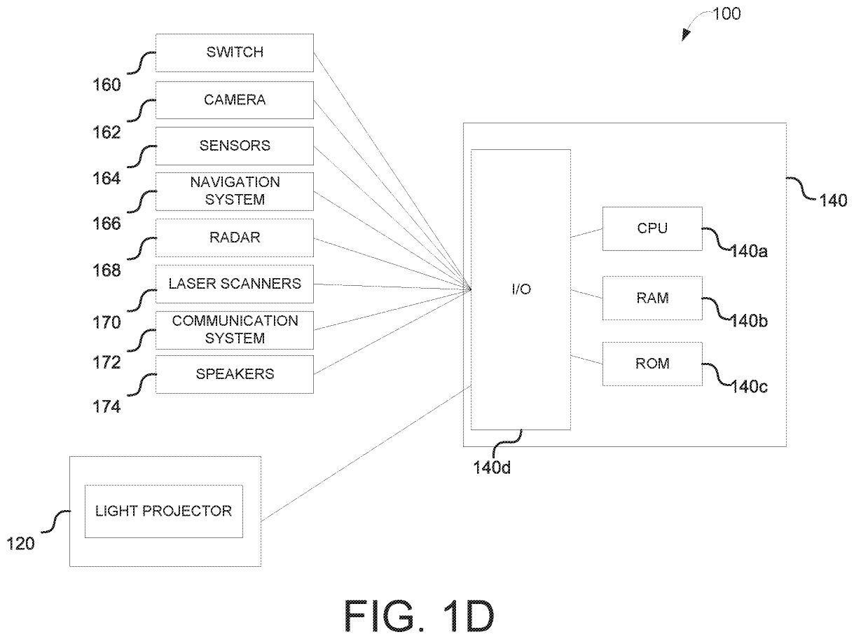

Referring to FIG. 1A, an image illustrating an example of a heads up display labeling of an object that is a vehicle for sale by a vehicle owner and/or a vehicle owner looking for friends in accordance with various embodiments of the disclosure. In particular, an autonomous vehicle features an object content presentation system 100 that can detect potential hazards and their distance from the vehicle (and an outline thereof) and alert an occupant via display module. For example, the display module integrates the alert into a high tech augmented heads up display or similar technology that allows the occupants to see the road and their surroundings in a completely different way. Furthermore, the heads up display by way of many examples in this disclosure integrates a live search of an on-line database as the autonomous vehicle drives along a road, e.g., pulling out of a parking garage or stall, and continuing down a road as illustrated in FIGS. 1A-1C.

Continuing with the FIG. 1A embodiment, when the autonomous vehicle makes its first turn out of a parking garage, its heads up display recognizes a vehicle, i.e., a white SUV. The heads up display calculates and displays a distance to the object, e.g., white SUV, for example, based on optical, infrared, microwave, millimeter wave or the like technology radar measurements. For instance, timed sequential light pulses that reflect off the surface of the white SUV, and captured by the autonomous vehicle.

In this example, the autonomous vehicle calculates and displays on a heads up display, the vehicle's distance to the white SUV of approximately 20 feet from a front of the autonomous vehicle. In this same example, the image of the white SUV, e.g., its physical characteristics including its license plate number, e.g., ZYNTMZ, and its current location, e.g., where the SUV is parked, is used in conjunction with an on-line database search. In this example, the on-line database research reveals that the white SUV is listed for sale by the owner, e.g., an advertisement was found on Craigslist, based on its physical characteristics and its description and cross-referenced with its approximate location.

Within the autonomous vehicle, the occupants, e.g., driver and passenger, based on their stored personnel profile likes, are both looking for an SUV such as the one displayed in FIG. 1A to purchase. As a result, both occupants may receive a text message to their respective mobile devices with information of this white SUV (with the image from the automobile) and a text message including the Craigslist listing of owner's contact information. At a later time, the occupants can review the information and if believed correct, and, if desired to purchase, one or more of the occupants can contact the owner regarding purchasing the SUV.

On the other hand, if the occupants were looking to meet new friends, and the on-line data search revealed the owner has an on-line advertisement, such as a friend request on one or more social media websites, such as Facebook, Twitter, or Instagram. Additionally, if one or more of the occupants has a profile that also desires friendship, then either or both of the occupants may contact the owner of the white SUV if either party is interested in meeting the other for coffee or a social event in their area.

FIG. 1B illustrates an image example of a heads up display labeling of an object that is a pedestrian/suspect in a crime in accordance with various embodiments of the disclosure. Continuing with FIG. 1B, after the autonomous vehicle completes a turn-out of the parking garage, a person is recognized and their distance displayed on a heads up display, e.g., directly ahead within 1 or more feet of the autonomous vehicle, by the object content presentation system 100 of the present disclosure.

Based on an on-line database search of the characteristics of this person captured by the camera 162 or light projector 120, this person may be a pedestrian and/or a suspect in an on-going criminal pursuit based on television footage. The autonomous vehicle may display a label “Pedestrian/Suspect in a Crime” and text information to a mobile phone of the occupants of the autonomous vehicle. If upon evaluation by the occupants of the accuracy of the media information on this person, one or more of the occupants of the autonomous vehicle can forward the current whereabouts of this person to a police agency to assist with an on-going criminal investigation.

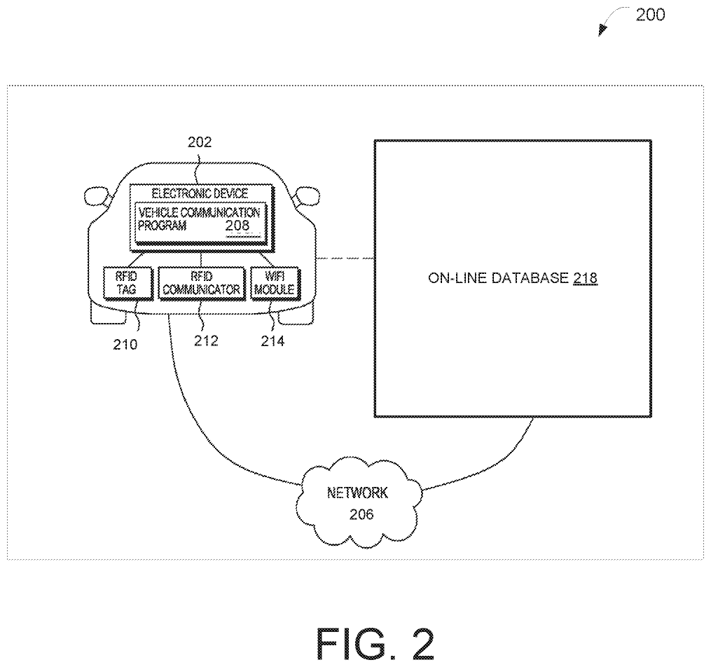

FIG. 1C is an image illustrating an example of a heads up display labeling of an object that is a couch/sofa in accordance with various embodiments of the disclosure. As illustrated in FIG. 2C, after leaving the driveway and heading down the road further, the autonomous vehicle encounters an object, as displayed in its heads up display the object may be 75 feet from the front of the autonomous vehicle. By the object content presentation system, this object is labeled a vehicle. Following the labeling of the object, the occupants can verify/correct the labeling/path of the autonomous vehicle and/or take manual control of its directional location, if applicable and appropriate, with the principles of this present disclosure.

If the label is determined by the occupant as incorrect, in some embodiments, the occupant can have the option to indicate such mislabeling to the vehicle, which can be used to improve the vehicle's recognition system. In one example, upon identifying the mislabeled item, the occupant may indicate the mislabeling by pointing at the mislabeled item by, e.g., finger-pointing at the item, staring at the item, or verbally describing the item.

In some implementations, the vehicle is equipped with suitable sensors to detect the finger pointing. Such a sensor may be an image sensor such as a camera. In some implementations, the image sensors or cameras are positioned such that they can only detect fingers pointed at the heads up display, and not the face or body of the occupants. In some implementations, the image sensors or cameras have limited resolution or sensing capability such that they can only detect the movement of the finger and cannot identify the occupant. In some implementations, the detected movement of the finger is projected in the computing system of the vehicle to determine the item that the finger points at.

In some embodiments, the vehicle is equipped with suitable sensors to detect the movement of the iris of the occupant. The sensors may be configured (e.g., with suitable positioning or resolution) such that they cannot identify the face of the occupant. In some implementations, the detected movement of the iris is projected in the computing system of the vehicle to determine the item that the eyes look at.

The vehicle, in some implementations, may be equipped with microphones and voice recognition systems to interpret instructions from the occupants. For instance, an occupant may say, “2 o'clock by the curb, a couch is mislabeled as a car.” Upon receiving the voice command, the vehicle can interpret the human language and input the interpreted information into the system.

Upon receiving the characterization of the mislabeling, the vehicle may share such characterization, along with other related information, with a server for improving the recognition system. The related information, in some embodiments, includes GPS location and driving direction of the vehicle when characterization is made. In some embodiments, one or more images or videos of the surroundings that include the mislabeled item is included. In some embodiments, the projected images and labels viewed by the occupants are included.

FIG. 1D is a schematic representation of object content presentation system 100 (utilized in prior FIGS. 1A-1C) of an autonomous vehicle in accordance with various embodiments of the disclosure. The object content presentation system 100 may include a light projector 120 controlled by the autonomous vehicle's electronic control unit 140 (ECU). The light projector 120 may transmit light from a light source, such as a laser diode or light-emitting diodes (“LED”). The terms “optical” and “light” may be used herein to refer generally to any visible, infrared, or ultraviolet radiation. The light projector may transmit and project visual information in the form of images and patterns in a two-dimensional or three-dimensional rendering. The light projection may also project data and information, such as in the form of letters and numbers indicating real time information regarding the autonomous vehicle itself. More information about the content of the light projector's projected information is discussed in further detail below.

In some instances, the autonomous vehicle may include an electronic control unit (“ECU”) 140. The ECU 140 may include a CPU 140a, a RAM 140b, a ROM 140c, and an I/O module 140d. The RAM 140b and ROM 140c may be used as, for example, memory storage devices to store data and instructions listing conditions and threshold requirements for turning on/off the light projector 120, as well as the visual content and information to be projected from the light projector 120. The ECU 140 may also be able to detect whether the autonomous vehicle 300 is turned on or off If on, the ECU 140 may then turn on the light projector 120. In some instances, the ECU 140 may turn on the light projector 120 via the switch 160 under certain conditions, such as when the ECU 140 detects one or more objects including pedestrians or other vehicles anywhere from 0 to 1000 feet from the autonomous vehicle. By way of example, the ECU 140 may be able to detect pedestrians utilizing any one of the vehicle cameras 162, sensors 164, navigation systems 166, radars 168, laser scanners 170, and communication systems 172 in communication with the ECU 140.

Additionally, the CPU 140a may perform various computations from the data gathered by the vehicle cameras 162, sensors 164, navigation systems 166, radars 168, laser scanners 170, and communications systems 172. Such computations may include determining the current trajectory path, e.g., along a direction of motion, of the autonomous vehicle based on the GPS route guidance input from the navigation system 166. Additionally, the trajectory path, e.g., along a direction of motion, of the autonomous vehicle may be continuously modified and updated and adjusted by continuously factoring in the immediate environmental and road conditions surrounding the autonomous vehicle.

By way of example, detecting for such environmental and road conditions may be determined by analyzing the one or more data, e.g., autonomous vehicle data, gathered by the vehicle cameras 162, sensors 164, navigation systems 166, radars 168, laser scanners 170, and communications systems 172. The CPU 140a may then determine the safest trajectory route, e.g., direction of motion, of the autonomous vehicle based on such factors and provided information. The I/O module 140d may be connected to various vehicle components, devices, and systems to detect certain environmental, road, and/or driving conditions to determine the upcoming trajectory path, e.g., direction of motion, of the autonomous vehicle. For example, the I/O module 140d may be connected to cameras 162, sensors 164, navigation systems 166, communication systems 172, radar 168, and laser scanners 170. These various vehicle components may be used individually or in combination with one another to detect the environment, road, and/or driving conditions in real time.

By way of example, cameras 162 may be mounted in the interior and/or exterior sections of the autonomous vehicle. In some embodiments, the cameras 162 may be a still camera and/or video camera that may capture images and videos of the front, sides, and rear surrounding areas of the vehicle. The cameras 162 may be oriented to take images and videos of preceding vehicles and oncoming vehicles, as well as pedestrians, objects, and road conditions surrounding the general vicinity of the vehicle.

In some instances, images captured by the cameras 162 may be processed with object recognition software to detect certain objects of interest. By way of example, the cameras 162 may capture images and/or videos of the surrounding vehicle environment, which may include potential pedestrians, road signs, oncoming vehicles, preceding vehicles, and the like. The images and/or videos may then be processed by the CPU 140a, where they may be filtered with object recognition software. To determine if any of the objects in the images and/or videos include objects (e.g., pedestrians, road signs, oncoming vehicles, preceding vehicles, headlights, tail lights, and the like) of interest, the object recognition software may include a datastore with reference materials. By way of example, the reference materials may also include information regarding shapes, pixel intensities, lines, and other information that can be used to help further identify the objects of interest in the images and/or videos. By detecting for certain objects surrounding the autonomous vehicle 300, the ECU 140 may be able to factor the presence of the identified objects and make the determination whether the autonomous vehicle's trajectory needs to be changed or modified. For example, if the object recognition software identifies a pedestrian up ahead in line with the autonomous vehicle's determined trajectory path, this may indicate to the ECU 140 that the autonomous vehicle must proceed to a slow complete stop before approaching the pedestrian or re-routing a new trajectory path away from the identified pedestrian up ahead.

There may also be a plurality of sensors connected to the I/O module 140d, where the sensors 164 may be used to detect various environmental, road, or driving conditions. By way of example, such sensors 164 may detect distance between vehicles (e.g. radar sensors), speed of current autonomous vehicle travel (e.g. accelerometer and speedometer), object detection (e.g. radar sensors), motion detection (e.g., motion sensors), moisture detection (e.g., moisture detection sensors), steering handling detection (e.g., steering wheel sensors), and the like. The sensors alone or in combination with the camera 162, navigation system 166, radar 168, the laser scanners 170, and communication systems 172 may be used to collect data in real time, which may then be processed by the CPU 140a. Thus, the sensors 164 may also be utilized to help determine a safe upcoming trajectory path, e.g., along a direction of motion, for the autonomous vehicle.

The navigation system 166 may also be connected to the I/O module 140d. The navigation system 166 may include a navigation processor, a navigation adjustment component, and a GPS component. In some embodiments, the navigation system 166 may determine the location of vehicle in real time and determine the current and upcoming road and traffic conditions using a GPS component (which may include or be a GPS receiver). In some embodiments, the navigation system 166 may receive information from third party service providers, such as current traffic information, weather information, road construction information, and the like. While the navigation system 266 may provide the quickest route or provide a route based on driver specifications (e.g., no toll road, no highways, no private roads, etc.), the autonomous vehicle may also utilize the camera 162, the sensors 164, the radar 168, the laser scanners 170, and the communication systems 172 to determine the safest upcoming trajectory of the autonomous vehicle in real time.

A radar 168 and laser scanner 170 may also be connected to the I/O module 140d. The radar 168 may utilize electromagnetic radiation to detect other vehicles or objects located near the autonomous vehicle. Additionally, the laser scanner 170 may emit a light beam such that when the light beam is reflected back after hitting a surface of an object in the environment, objects may then be detected. Based on vehicles or objects detected via the radar 168 and laser scanner 170, the ECU 140 may determine the safest upcoming trajectory of the autonomous vehicle in real time.

By way of further example, the communication system 172 may also be connected to the I/O module 140d. The communication system 172 may include telematics systems, such as on-board diagnostics (OBD) systems installed within autonomous vehicles, which may be configured to access vehicle computers and transmit vehicle data to the CPU 140a. In some instances, the communication system 172 may also include a Bluetooth system to enable communication between the vehicle and the driver's mobile phone. This may allow any data collected from a mobile device, such as location information, to be transmitted to the CPU 140a for data processing.

Additionally, the communication system 172 may also include vehicle-to-vehicle communication systems and/or vehicle-to-infrastructure communications systems, which can be used to share data and information amongst autonomous vehicles and/or data and information from roadside units. Shared data and information may include data collected by the autonomous vehicle, such as safety information, locations of curved or hilly sections of road, location of other autonomous vehicles, presence of upcoming of road signs, and the like. The ECU 140 may then use such gathered information to further determine the safest upcoming trajectory of the autonomous vehicle in real time.

The communication system 172 is depicted in FIG. 2, which is a schematic representation of a vehicle communication system 200. The distributed data processing environment may include an electronic device 202 that is interconnected over network 206. By way of example, the electronic device 202 may be an ECU, a transmission control unit (TCU), an integrated vehicle computer, a laptop computer, a tablet computer, a smartphone, or any programmable electronic device capable of receiving at least inputs and communicating with other electronic devices, network 206, RFID tag 210, RFID communicator 212, and WI-FI module 214.

A vehicle communication program 208 may each reside in electronic device 202. The vehicle communication program 208 may have the ability to send and receive messages concerning safety, environment, road, and driving conditions.

RFID tag 210 may be radio-frequency identification tag(s) which may respectively communicate with vehicle communication program 208 and provide vehicle information. In one embodiment, the vehicle information can include vehicle identification number, where communication program 208 may have the ability to determine information about the vehicle, such as the make and model of the vehicle. The RFID communicators 212 may communicate with communication program 208 to send messages, receive messages, and identify any vehicles in the vicinity based on the RFID tag 210.

In another embodiment, the Wi-Fi module 214 can respectively communicate with vehicle communication program 208. For example, the Wi-Fi module 214 allows vehicle communication programs 208 to send and receive messages with electronic device 202. The Wi-Fi module 214 can be associated with a vehicle, where each Wi-Fi module 214 utilizes a unique IP address.

In general, network 206 can be any combination of connections and protocols that can support communications with electronic device 202. Network 206 can include, for example, a local area network (LAN), a wide area network (WAN), such as the internet, a cellular network, or the combination of the preceding, and can further include wired, wireless, and/or fiber optic connections.

Thus, by way of example, data gathered from the above mentioned cameras 162, sensors 164, navigation system 166, radar 168, and laser scanners 170 can be shared with the vehicle utilizing the communication system 172. In other words, data provided by the communication system 172 may then be analyzed, factored and assessed to further help determine the safest trajectory path of the autonomous vehicle.

Furthermore, referring back to FIG. 1, speakers 174 may also be connected to the I/O module 140d. The speakers 174 may be configured so that the audio may be heard by pedestrians or nearby drivers within the immediate vicinity of the autonomous vehicle. By way of example, the ECU 140 may provide an audible alert or notification via the speakers 174 when the autonomous vehicle detects a likelihood that its upcoming trajectory path will result in potentially harmful or dangerous conditions for nearby pedestrians or drivers. The CPU 140a may be able to make such a calculated determination using the camera 162, navigation system 166, radar 168, the laser scanners 170, and communication systems 172 as described in detail above. In some instances, the speakers 174 may transmit an audible notification in the instance that the CPU 140a determines that a collision or other dangerous scenario is expected to occur within 1000 feet of the autonomous vehicle. Thus, the audible notification from the speakers 174 may provide a warning mechanism to nearby pedestrians to stay clear and away from the autonomous vehicle.

Furthermore in some embodiments, the communication system 172 may be in communication with other vehicles nearby with their own corresponding compatible communication system configured to transmit and receive communication from the communication system 172. By way of example, when the autonomous vehicle detects a likelihood of collision within 1000 ft, the communication system 172 of the autonomous vehicle may alert other vehicles nearby of the potential dangerous scenario expected to occur. This may then cause other vehicles to stay clear and away from the autonomous vehicle and prevent any harm or collisions.

Additionally in some instances, the light projector 120 may be turned on when the camera 162, sensors 164, radar 169, and/or laser scanners 170 detect certain objects, such as the presence of nearby pedestrians or other drivers or objects. Thus when the object recognition software 208 or other in-vehicle devices identify the presence of pedestrians or other vehicles, the ECU 140 may command the light projector 120 to be switched on. By way of example, when the camera 162 identifies presence of pedestrians or objects within 1000 ft. from the front end or sides of the autonomous vehicle, the ECU 140 may turn on the light projector 120 via the switch 160.

Furthermore, in some instances, when the object recognition software confirms the absence of pedestrian presence, the ECU 140 may command the light projector 120 to be turned off and save power and energy. In other instances, the light projector 120 may be turned on when the ECU 140 detects the presence of other vehicles or objects sharing the road with the autonomous vehicle. Again, when the ECU 140 determines that no vehicles or objects are nearby, such as within 1000 feet from the autonomous vehicle by way of example, the light projector 120 may be turned off via the switch 160.

Upon determining the immediate and upcoming trajectory route, the ECU 140 may control the light projector 120 and project the determined upcoming trajectory path on a surface of the road in front of the autonomous vehicle. The upcoming trajectory path may be determined based on the information provided by the cameras 162, sensors 164, navigation systems 166, radar 168, laser scanners 170, communication systems 172, and speakers 174.

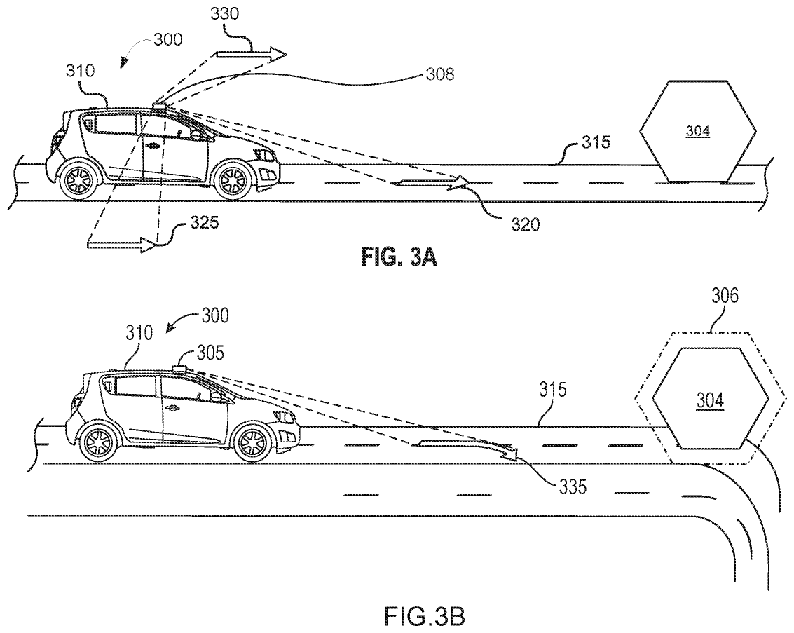

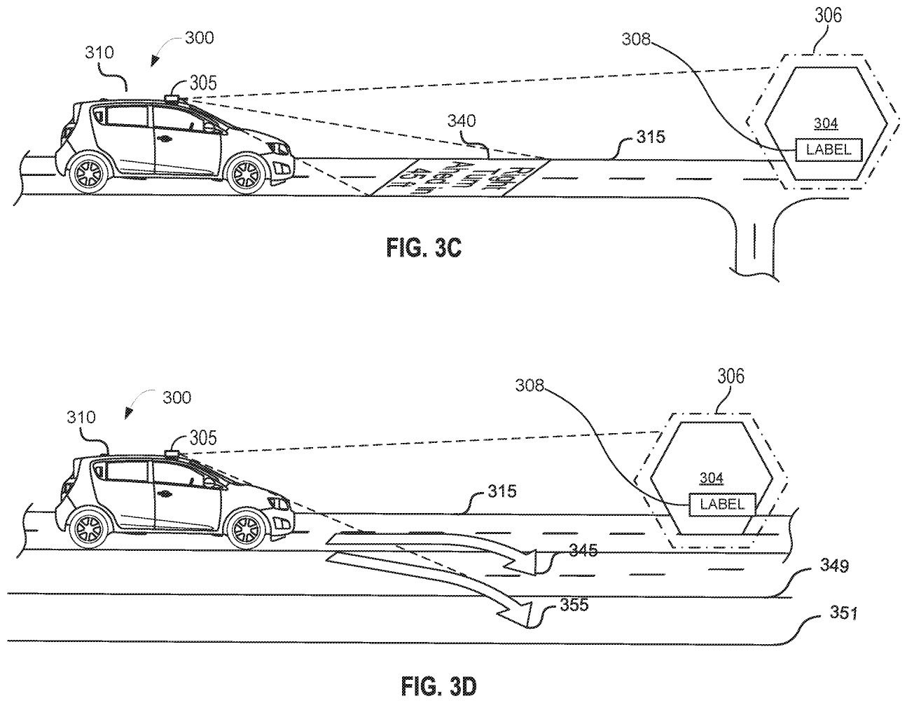

FIG. 3A is an illustration of an autonomous vehicle 300 recognizing an object 304 in a direction of motion of an upcoming trajectory path 320, 325, 330 along a road 315 in accordance with various embodiments.

As illustrated, sensors 164 with cameras 162 receive autonomous vehicle sensor data to capture images (or image data) of regions surrounding the autonomous vehicle. For example, cameras 162 capture images in front of, on side of, and behind the autonomous vehicle. For example, the system may analyze sensor data and recognize an object 304 in a direction of motion of the autonomous vehicle 300. For example, the object 304 may be a car, pedestrian, couch, rocks, disabled vehicle, dangerous traveling vehicle, car interested in buying, driver looks drunk, vehicle owner interested in making friends, car for sale, pot hole in the road or other like or other interest of the occupant.

As illustrated, a light projector 305 may be placed on a top surface 310 of an autonomous vehicle 300, such as the top roof above the windshield of an autonomous vehicle 300. However, it should be noted that the light projector 305 may be located in other areas on the autonomous vehicle 300 with an unobstructed illuminating path to the surface of a road 315, such as areas near the front bumper, front hood, or dashboard area.

In some embodiments, the light projector 305 may include a light source and concentrate the light rays onto a surface of the road 315 near the autonomous vehicle 300. In other instances, the light projector 305 may include one or more lasers and emit a laser beam(s) onto a surface of the road 315 near the autonomous vehicle 300. In some instances, the light projector 305 may utilize both a laser beam and a light beam to project the necessary visual information on a surface of the road. For example, the laser beam may be utilized to project straight lines or three-dimensional patterns and images. Furthermore, a light beam may be used in conjunction with the laser beam to help project patterns, images, and information onto the surface of the road 315 near the autonomous vehicle 300. By way of further example, the laser beams may be emitted to project straight lines and arrows while the light beams may be simultaneously emitted to project a visual structure, such as a layout 306 of an object 304, e.g., a pet, an animal, another vehicle, or anything having physical dimensionality and may be in a path of the autonomous vehicle 300. Thus, both the laser beams and light beams may be simultaneously emitted to project the necessary visual information onto the surface of the road 315.

By way of example, once the autonomous vehicle 300 computes and obtains its trajectory path, as described in detail with reference to FIGS. 1-2, the upcoming trajectory path may be illuminated onto a surface of the road immediately in front of the autonomous vehicle 300. It should be noted that the trajectory path to be projected on the road 315 may be the immediate trajectory path of the autonomous vehicle and may be anywhere from 1 to 1000 feet of the autonomous vehicle's upcoming trajectory path.

In some embodiments, the upcoming trajectory path 320 may be illuminated anywhere from 1 to 100 feet in front of the autonomous vehicle 300. In further embodiments, the upcoming trajectory paths 325 or 330 may even be illuminated onto the surface of the road and/or ground on the sides of the autonomous vehicle 300. The upcoming trajectory path may be illuminated anywhere from 1 to 100 feet from the front or sides of the autonomous vehicle 300. The upcoming trajectory path 320 may be the suggested trajectory path and may be changed based on the occupant input received by the autonomous vehicle 300.

As illustrated in FIG. 3A, the light projector 305 may emit information regarding the upcoming trajectory paths 320, 325 and 330 in front or sides of the autonomous vehicle. In some instance, the information may come in the form and shape of arrows to indicate the upcoming trajectory path of the autonomous vehicle 300. As further indicated in FIG. 3A, if the autonomous vehicle is currently travelling in a straight road and is expected to continue in a straight path, as further indicated by the upcoming trajectory paths 320, 325, 330 (e.g., straight arrow indicators 320, 325, 330) that can be projected onto the road 315 by the light projector 305.

As further illustrated in FIG. 3B, an illustration of an autonomous vehicle displaying a layout 306 of the object 304 on a heads up display along an outline of the object 304 in a direction of motion along a road in accordance with various embodiments. For example, the light projector 305 may project a layout 306 of the object 304 that corresponds to the object 304 in an immediately upcoming trajectory path. For example, a layout 306 of the object 304 may be a perimeter area or a 2-D or 3-D augmented reality image or representation of the object 304 on the object itself. As illustrated, a light beam may be used in conjunction with the laser beam to project a layout 306 of the object 304 on a heads up display along an outline of the object 304 in a direction of the motion of the autonomous vehicle 300. By way of further example, the laser beams may be emitted to project straight lines and arrows while the lights beams may be simultaneously emitted to project a layout 306 of the object 304, e.g., a pedestrian, another vehicle, a dog, a cat, or other living or physical structure.

Thus, both the laser beams and light beams may be simultaneously emitted to project the layout 306 of the object 304 onto the object 304. Advantageously, this layout 306 of the object 304 is a highlighted perimeter so that the object 304 may be more visible to the occupant even in adverse weather or environmental conditions, e.g., rain, snow, sleet, flooding, road constructions, closed highway lanes, concrete barriers or posts that are proximate to the object 304.

Furthermore, FIG. 3B illustrates what happens as the autonomous vehicle 300 is expected to approach an object 304. As a result, the light projector 305 may project light that indicates the autonomous vehicle's 300 adjusted direction of motion along a curved trajectory path immediately ahead. In one embodiment, the light projector 305 may illuminate light arrows to convey the autonomous vehicle's 300 upcoming trajectory path and an approximate distance from the layout 306 of the object 304. In further examples, the projected arrows (e.g., arrow 335 of FIG. 3B) may include a straight arrow, right-elbow arrow, left-elbow arrow, arc arrow in a clockwise direction, arc arrow in a counter clockwise direction, cyclic arrow in clockwise direction, cyclic arrow in a counter clockwise direction, U-shaped arrow, and the like in order to best and accurately convey the autonomous vehicle's 300 upcoming trajectory path.

While the projection of arrows may provide a quick visual indication of the autonomous vehicle's 300 immediate trajectory path, the indication of arrows alone may not provide the most obvious or precise indication of its upcoming trajectory path to others. As a result, the light projector 305 may project words and numbers (see FIG. 3C) onto a surface of the road or a heads up display to convey its immediately upcoming trajectory path, e.g., direction of motion.

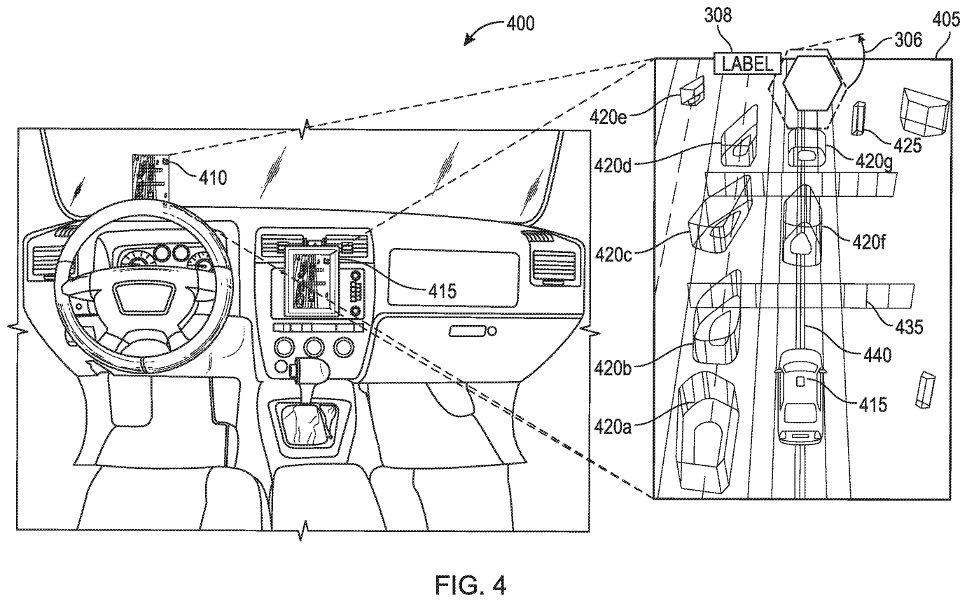

FIG. 3C illustrates an autonomous vehicle identifying and labeling the object 304 on the layout 306 of the object 304, on a heads up display, based on a live search of an on-line database 218 in a direction of motion along a road in accordance with various embodiments. For example, an object 304 and/or a layout 306 of an object 304 are/is searched on an on-line database 218. For example, on-line database 218 may be searched using commercial Internet search engines, such as Google, Bing or Yahoo, that utilize image and/or object recognition software 208 to compare the layout 306 of the object 304 and/or the object 304, e.g., its shape, color, size, any text, with available pictures and text in its on-line database 218 to identify the object 304. Following this image comparison, the commercial Internet search engine outputs a text (e.g., label 308) that indicates an identity of the object 304. Afterwards, the object 304 by electronic device 202 is labeled and the image of label 308 placed on the layout 306 of the object 304. As illustrated, the label 308 is displayed upon autonomous vehicle 300 trajectory path and/or displayed on a heads up display or computer screen 410, 415 (see FIG. 4, for example) within the autonomous vehicle 300, 400. For example, a label 308 will be projected by the light projector 305 on a layout 306 of the object 304, for example, a heads up display, matching that text found in the on-line database 218 search, for example, “CAT”, DOG″, “CHICKEN”, “COUCH”, “DANGEROUS VEHICLE”, “EMERGENCY VEHICLE”, “CRIME SUSPECT VEHICLE” and other physical structure or living organisms, or on a computer screen 410, 415 within the autonomous vehicle 300 and 400.

As such, the heads up display principles of the present disclosure, by way of example, extends to replace rear view and external mirrors with cameras and virtual displays. As such, this system of the present disclosure incorporates a 3D instrument labeling and layout display system linked to heads up tracking technology that delivers key information unobstructively as well as gives occupants a better understanding/illustration/awareness of their surroundings.

Furthermore, by way of example, the principles of the present disclosure provide augmented reality windshields in autonomous vehicles that provide a more pleasant driving and passenger experience. In addition, the principles of the present disclosure create a heads up display that provides driving related information (object labeling, object recognition, object layout) that is in the line of sight of the occupants, so that the occupants can correct/verify an adjusted direction of the autonomous vehicle before making the turn.

In some embodiments, the autonomous vehicle's upcoming trajectory path may be provided in words and numbers. Here, the figure (e.g., FIG. 3C) provides an example where the light projector 305 projects information on the augmented display (heads up display) indicating that the autonomous vehicle 300 will proceed to make a “RIGHT TURN AHEAD IN 45 FT.” As such, a pedestrian approaching or located near the autonomous vehicle may be able to quickly and accurately assess the autonomous vehicle's 300 precise upcoming trajectory upon viewing the information displayed on the surface of the road 315 or a head up display within the autonomous vehicle. However, it should be noted that in some instances, the arrow and words and/or numbers may be projected onto a surface of the road from the light projector 305 or at the sides of the autonomous vehicle as depicted in FIGS. 3A-3D.

As such, the augmented display of the present disclosure makes it possible to virtually test several driving scenarios in real-life driving conditions to anticipate the detection of these dangers, all from a virtual safety of a virtual environment. Furthermore, the heads up display makes the object image hover in space before an occupant's eyes, and directing them to take actions, including manual control if necessary, by directing their attention around an object just like playing a video game. For example, speedometer readings, speed view information including radio stations, U-tube stations, multi-media playlists, and the like, including turn-by-turn directions can be provided (as a windshield overlay) within a field of vision (e.g., direct line of sight) of the occupants.

In some embodiments, the light projector 305 may project other information than an upcoming trajectory path of the autonomous vehicle's 300. For example, in some instances, the light projector 305 may project the autonomous vehicle's current speed. Such information may be provided by the sensors from the autonomous vehicle 300, such as the speedometer.

In related embodiments, identifying and labeling 308 the object 304 on the layout 306 of the object 304 based on a live search of an on-line database 218 includes checking by the occupant an accuracy of the identifying and labeling 308 of the object 304; and confirming or changing to make accurate by the occupant the labeling 308 of the object 304 on the layout 306 of the object 304. In yet another example, identifying and labeling 308 the object 304 on the layout 306 of the object 304 based on a live search of an on-line database 218 includes confirming an agreement by the occupant of the identifying and the labeling of the object 304 as an interest to the occupant; and electronically communicating any contact information of the interest to the occupant.

For example, the interest may be the occupant would like to purchase certain make and mode of vehicle and the contact information will be electronically transmitted to this occupant to a mobile device. In another related example, the identifying and labeling 308 the object 304 on the layout 306 of the object 304 based on a live search of an on-line database 218 includes displaying an augmented image either inside or outside the autonomous vehicle 300, 400 including an identifying labeling 308 on the object 304 so that the occupant can visualize the object 304 and confirm or deny its identity.

FIG. 3D is an illustration of an autonomous vehicle presenting an adjusted direction of motion along a road and/or on a screen to an occupant in accordance with various embodiments. The autonomous vehicle may be able to present the adjusted direction by projecting an upcoming stopping point or change of direction on a surface of a road or the heads up display in accordance with various embodiments. In some instances, the light projector 305 may project a 2-dimensional or 3-dimensional pattern along the road near the autonomous vehicle 300. By way of example, the light projector 305 may project a rendering of a 2-dimensional or 3-dimensional image in front of the autonomous vehicle 300 to indicate the exact area on the road where the autonomous vehicle is expected to stop. It should be noted that the light projector 305 is not limited to a specified pattern or figure. Rather, the light projector 305 may project a STOP sign or any other visual message to relay the autonomous vehicle's stopping point. By way of example, such visual messages may include other road signs and symbols and pictures to convey visual information to nearby pedestrians and other drivers.

In related embodiments, the presenting the adjusted direction of motion includes the presenting the adjusted direction of motion within the autonomous vehicle 300. In another example, the presenting the adjusted direction of motion includes a projecting of an upcoming trajectory path (e.g., light arrow 320, 335, 345, and/or 355) (see FIG. 3A-3D) in-front of the direction of motion of the autonomous vehicle 300 along a road to indicate the adjusted direction of motion of the autonomous vehicle. In yet another example, the presenting the direction of motion includes instructing the occupant who is a driver that a dangerous or difficult condition has occurred and to take manual control of the autonomous vehicle 300.

FIG. 4 is an illustration of an autonomous vehicle 400 that allows the occupant to confirm the identifying and the labeling 308 of the object 304 with its upcoming trajectory path displayed on screens 410 and 415. Thus, the autonomous vehicle's upcoming trajectory path may also be conveyed to the occupant, e.g., driver, passenger, or other individual that has visual information about the autonomous vehicle. In some embodiments, such information may be displayed on display screens 410 and 415 within the cabin of the autonomous vehicle 400.

As illustrated, either one or both of the display screens 410, 415 may illustrate the road and environmental conditions surrounding the autonomous vehicle 400. The illustrated road and environmental conditions may be detected by the autonomous vehicle's 400 camera, navigation system, radar, the laser scanners, and communication systems. Such identified objects and road conditions may be identified and presented on the display screen 410 or display screen 415. By way of example, the display screen 410, 415 may present the following information as displayed in enlarged format at the display screen 405 (enlarged version of display screens 410, 415). Such information may include the autonomous vehicle's current location and may even identify detected road and environmental conditions, such as other vehicles 420a, 420b, 420c, 420d, 420e, 420f, and 420g, pedestrians 425, and object 304, layout 306 of object 304, and label 308 of object 304.

Additionally, the display screens 410 and 415 may also display the autonomous vehicle's trajectory path 440 as well as the information the light projector is projecting onto the surface of the road. For example, FIG. 4 depicts that the autonomous vehicle 400 is expected to travel in a straight trajectory path, as indicated by the straight trajectory path visual line 440. Furthermore, in this example, the autonomous vehicle 400 is further expected to change lanes at a location immediately ahead, and thus the light projector will display a 2-dimensional or 3-D dimensional image 435 at the select area along the road in a direction of motion of the autonomous vehicle and where it is expected to change lanes (or pull over) along the road. As a result, the display screen 410, 415 may indicate such a 2-D or 3-D dimensional image 435, thus notifying the occupants (driver and passenger) of the upcoming trajectory path and ask for confirmation of the adjusted direction of motion of the autonomous vehicle 400. As illustrated, the occupants can select yes to adjust the direction of motion. As an example, to adjust the direction of motion of the autonomous vehicle, one or more autonomous vehicle actions may include any of steering, accelerating, and braking.

As illustrated, the adjusted direction of motion may be changing lanes using trajectory path 345 (see FIG. 3D) to road 349 (e.g., second lane 349) to avoid the object 304 (e.g., a couch or sofa that fell off a truck that is blocking road 315 (e.g., first lane 315) and change to road 347 (e.g., second lane 347). In a related embodiment, the adjusted direction of motion is pulling over off the road 347 to road shoulder 351 using trajectory path 355 (See FIG. 3D) when the object 304, e.g., an emergency vehicle, such as ambulance, fire truck, stolen car, crime suspect vehicle, is coming toward the autonomous vehicle 300 to prevent crashing into the autonomous vehicle 300 and injuring its occupants.

In yet another related embodiment, the adjusting the direction of motion of the autonomous vehicle 300 based on confirmation by an occupant of the identifying and the labeling 308 of the object 304 utilizing one or more autonomous vehicle actions includes adjusting the direction of motion of the autonomous vehicle 300, 400. The adjusting the direction of motion of the autonomous vehicle can be based on a recognition of characteristics when the object 304 is a vehicle having a license plate that is confirmed by the occupant as being a suspect vehicle identified from the on-line database 218 as vehicle of interest. A vehicle of interest can be a vehicle, such as but not limited to, that has been as been stolen, in a recent crime, or has been published on the on-line database 218 as being in an active car chase. In this same example, furthermore, upon occupant confirming that object 304 is suspect vehicle, a whereabouts of the suspect vehicle can be reported via a telephone communication to a police agency as a possible crime suspect.

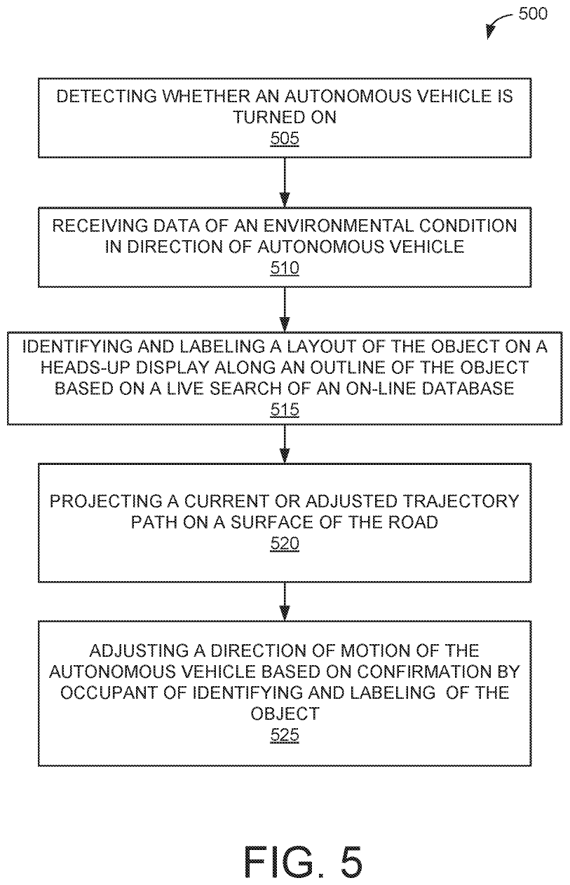

FIG. 5 is an exemplary process 500 for an object content presentation system of an autonomous vehicle in accordance with various embodiments. By way of example, the process may proceed at step 505, where the autonomous vehicle with a light projector system may detect whether the autonomous vehicle is turned on.

Next, at step 510, the autonomous vehicle may receive autonomous vehicle data of the environmental conditions in a direction of motion of the autonomous vehicle. As described above in detail with reference to FIGS. 1-4 the autonomous vehicle may recognize an object in a direction of motion and identify its surrounding environment, road, and driving conditions based on the data collected from its in-vehicle devices, such as the cameras, sensors, navigation system, radar, laser scanner, and communication system. By way of example, one or more of the autonomous vehicle data received from one or more of the in-vehicle devices may be used to display a layout of an object, for example, using a light projector, on a heads up display along an outline of the object along the road on a trajectory route for the autonomous vehicle. In one example, the presenting the adjusted direction of motion includes the presenting the adjusted direction of motion within the autonomous vehicle. In yet another example, the presenting the adjusted direction of motion includes a projecting of a light arrow in-front of the direction of motion of the autonomous vehicle along a road to indicate the adjusted direction of motion of the autonomous vehicle. In yet another related example, the presenting the direction of motion includes instructing the occupant who is a driver that a dangerous or difficult condition has occurred and to take manual control of the autonomous vehicle.

Next, at step 515, the autonomous vehicle may identify and label the layout of the object based on a live search of an on-line database on the current or upcoming trajectory path of the autonomous vehicle. The trajectory path may be determined from GPS route guidance provided by the navigation system. Additionally, the trajectory path may also be determined based on the environmental conditions detected by the autonomous vehicle. Thus, the trajectory path may be continuously updated in real time based on the real environmental conditions detected by the autonomous vehicle. In one related example, identifying and labeling the layout of the object based on a live search of an on-line database includes checking by the occupant an accuracy of the identifying and labeling of the object; and confirming or changing by the occupant the labeling of the layout of the object. In yet another related example, the identifying and labeling the layout of the object based on a live search of an on-line database includes confirming agreement (via user input, e.g., voice input, manual input, etc.) by the occupant of the identifying and the labeling of the object as an interest to the occupant; and communicating electronically information any contact information of the interest to the occupant. In yet another related example, identifying and labeling the layout of the object based on a live search of an on-line database includes displaying an augmented image including an identifying labeling on the object so that the occupant can visualize the object and confirm or deny its identity.

Next, at step 520, the light projector from the autonomous vehicle may project its current or adjusted trajectory path on a surface of the road to an occupant of the autonomous vehicle. In some instances, the projection may be projected onto a surface of the road immediately in front of the autonomous vehicle. In other instances, the projection may be projected onto a surface of the road or sidewalk on the sides of the autonomous vehicle so that the projection may be more easily viewed by pedestrians or other drivers. In yet other embodiments, the projection may be projected onto the interior or exterior of the windshield of the vehicle as a heads up display for the occupants of the vehicle.

Next at step 525, the autonomous vehicle may adjust the direction of motion of the autonomous vehicle based on confirmation by the occupant of the identifying and the labeling of the object utilizing one or more autonomous vehicle actions. As illustrated in FIGS. 1-4 above, one or more autonomous vehicle actions include any of steering, accelerating, and braking. In a related embodiment, the presenting the adjusted direction of motion includes the presenting the adjusted direction of motion within the autonomous vehicle. In a related embodiment, adjusting the direction of motion of the autonomous vehicle is based on confirmation by an occupant of the identifying and the labeling of the object. By way of example, adjusting the direction of motion of the autonomous vehicle is performed by utilizing one or more autonomous vehicle actions that is based on the recognition characteristics of the object. In one instance, the occupants confirm the identity of the object based on characteristics that the object is a vehicle having a license plate of a suspect vehicle that was identified based on the on-line database search. By way of example, the suspect vehicle can be identified as being stolen, in a recent crime, or having been published on the on-line database as being in a car chase. In one related embodiment, the suspect vehicle whereabouts may be reported via electronic communication to a police agency as a possible crime suspect.

In some instances, the light projector and/or the object content presentation system may be turned on (or activated) in certain environmental conditions, such as when the autonomous vehicle detects the presence of pedestrians or other vehicles near the autonomous vehicle. By way of example, the autonomous vehicle may project its upcoming or adjusted trajectory path when it detects pedestrians or other vehicles within 1000 feet from the autonomous vehicle. In other instances, the light projector or the object presentation system may turn on whenever the autonomous vehicle is turned on.

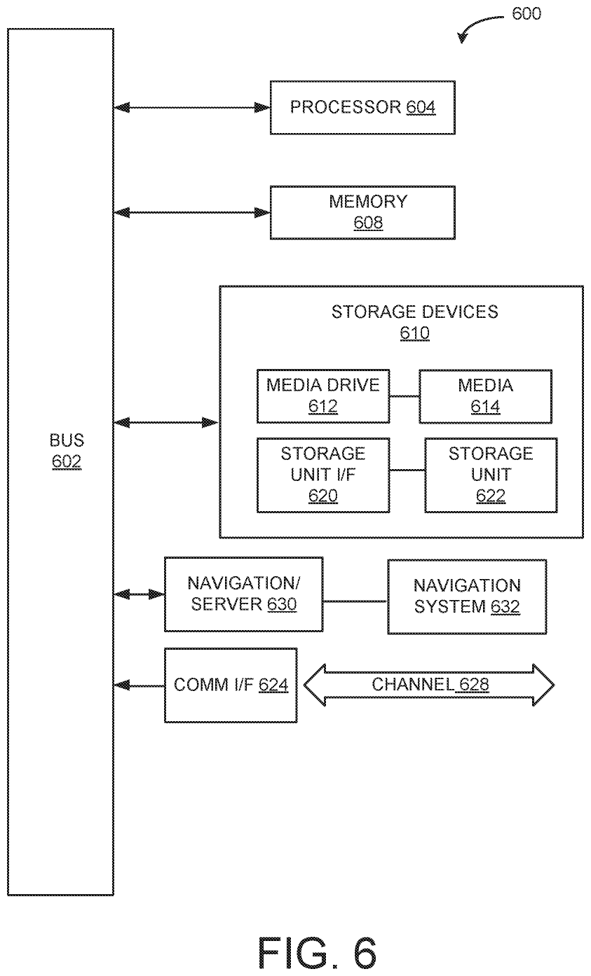

As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up navigation system 630 and its component parts, navigation server/network 632 and controller 650. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, and optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or soft modem, a network interface (such as an Ethernet, network interface card, WiMedia, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system comprising:
one or more processors; and
memory storing instructions that, when executed by the one or more processors, cause the system to perform:
obtaining autonomous vehicle sensor data of an autonomous vehicle;
recognizing an object in a direction of motion of the autonomous vehicle based on the autonomous vehicle sensor data;
displaying a layout of the object on a heads up display along an outline of the object;
identifying and labeling the layout of the object based on a live search of an on-line database;
presenting an adjusted direction of motion to an occupant of the autonomous vehicle; and
adjusting the direction of motion of the autonomous vehicle based on confirmation by the occupant of the identifying and the labeling of the object utilizing one or more autonomous vehicle actions.

2. The system of claim 1, wherein the one or more autonomous vehicle actions include any of steering, accelerating, and braking.

3. The system of claim 1, wherein the presenting the adjusted direction of motion comprises the presenting the adjusted direction of motion within the autonomous vehicle.

4. The system of claim 1, wherein the presenting the adjusted direction of motion comprises a projecting of a light arrow in-front of the direction of motion of the autonomous vehicle along a road to indicate the adjusted direction of motion of the autonomous vehicle.

5. The system of claim 1, wherein the presenting the direction of motion comprises instructing the occupant who is a driver that a dangerous or difficult condition has occurred and to take manual control of the autonomous vehicle.

6. The system of claim 1, wherein identifying and labeling the layout of the object based on a live search of an on-line database comprises checking by the occupant an accuracy of the identifying and labeling of the object; and confirming or changing to make accurate by the occupant the labeling of the layout of the object.

7. The system of claim 1, wherein identifying and labeling the layout of the object based on a live search of an on-line database comprises confirming an agreement by the occupant of the identifying and the labeling of the object as an interest to the occupant; and communicating electronically information any contact information of the interest to the occupant.

8. The system of claim 1, wherein adjusting the direction of motion of the autonomous vehicle based on confirmation by an occupant of the identifying and the labeling of the object utilizing one or more autonomous vehicle actions comprises adjusting the direction of motion of the autonomous vehicle based on a recognition of characteristics when the object is a vehicle having a license plate that is confirmed by the occupant as being a suspect vehicle identified from the on-line database as being stolen, in a recent crime, or has been published on the on-line database as being in an active car chase; and reporting a whereabouts of the suspect vehicle via a telephone communication to a police agency as a possible crime suspect.

9. The system of claim 1, wherein identifying and labeling the layout of the object based on a live search of an on-line database comprises displaying an augmented image either inside or outside the autonomous vehicle including an identifying labeling on the object so that the occupant can visualize the object and confirm or deny its identity.

10. A method being implemented by a computing system including one or more physical processors and storage media storing machine-readable instructions, the method comprising:
obtaining autonomous vehicle sensor data of an autonomous vehicle;
recognizing an object in a direction of motion of the autonomous vehicle based on the autonomous vehicle sensor data;
displaying a layout of the object on a heads up display along an outline of the object;
identifying and labeling the layout of the object based on a live search of an on-line database;
presenting an adjusted direction of motion to an occupant of the autonomous vehicle and
adjusting the direction of motion of the autonomous vehicle based on confirmation by the occupant of the identifying and the labeling of the object utilizing one or more autonomous vehicle actions.

11. The system of claim 10, wherein the one or more autonomous vehicle actions include any of steering, accelerating, and braking.

12. The system of claim 10, the presenting the adjusted direction of motion comprises the presenting the adjusted direction of motion within the autonomous vehicle.

13. The system of claim 10, wherein the presenting the adjusted direction of motion comprises a projecting of a light arrow in-front of the adjusted direction of motion of the autonomous vehicle along a road to indicate the adjusted direction of motion of the autonomous vehicle.

14. The system of claim 10, wherein the presenting the direction of motion comprises instructing the occupant who is a driver that a dangerous or difficult condition has occurred and to take manual control of the autonomous vehicle.

15. The system of claim 10, wherein identifying and labeling the layout of the object based on a live search of an on-line database comprises checking by the occupant an accuracy of the identifying and labeling of the object; and confirming or changing by the occupant the labeling of the layout of the object.

16. The system of claim 10, wherein identifying and labeling the layout of the object based on a live search of an on-line database comprises confirming agreement by the occupant of the identifying and the labeling of the object as an interest to the occupant; and communicating electronically information any contact information of the interest to the occupant.

17. The system of claim 10, wherein adjusting the direction of motion of the autonomous vehicle based on confirmation by an occupant of the identifying and the labeling of the object utilizing one or more autonomous vehicle actions comprises adjusting the direction of motion of the autonomous vehicle based on a recognition of characteristics when the object is vehicle having a license plate that is confirmed by the occupant as being a suspect vehicle identified from the on-line database as being stolen, in a recent crime, or has been published on the on-line database as being in a car chase; and reporting via electronic communication whereabouts of the suspect vehicle to a police agency as a possible crime suspect.

18. The system of claim 10, wherein identifying and labeling the layout of the object based on a live search of an on-line database comprises displaying an augmented image including an identifying labeling on the object so that the occupant can visualize the object and confirm or deny its identity.

19. A non-transitory computer readable medium comprising instructions that, when executed, cause one or more processors to perform:
obtaining autonomous vehicle sensor data of an autonomous vehicle;
recognizing an object in a direction of motion of the autonomous vehicle based on the autonomous vehicle sensor data;
displaying a layout of the object on a heads up display along an outline of the object;
identifying and labeling the layout of the object based on a live search of an on-line database;
presenting an adjusted direction of motion to an occupant of the autonomous vehicle and
adjusting the direction of motion of the autonomous vehicle based on confirmation by the occupant of the identifying and the labeling of the object utilizing one or more autonomous vehicle actions.

20. The non-transitory computer readable medium of claim 19, wherein the one or more autonomous vehicle actions include any of steering, accelerating, and braking.
